(19) United States
(12) Patent Application Publication
(10) Pub. No.: US 2005/0144517 A1
(43) Pub. Date: Jun. 30, 2005

(54) Systems and methods for bypassing logical to physical address translation and maintaining data zone information in rotatable storage media

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 11/018,171

(22) Filed: Dec. 20, 2004

Related U.S. Application Data
(60) Provisional application No. 60/533,458, filed on Dec. 30, 2003.
(60) Provisional application No. 60/533,358, filed on Dec. 30, 2003.
(60) Provisional application No. 60/533,108, filed on Dec. 30, 2003.
(60) Provisional application No. 60/533,461, filed on Dec. 30, 2003.

(51) Int. Cl. G06F 12/08; G06F 12/16

(52) U.S. Cl. 714/8; 711/4; 711/203; 711/207

(57) ABSTRACT

Information relating to the translation of logical block addresses to physical addresses of rotatable storage media can be written to memory or cached. For example, a cache entry can identify a recently requested logical block address, a corresponding physical address, and a range of non-defective sectors. Information such as a number of sectors on a track with a physical address, number of sectors on a surface and in a group with the physical address, and various skew parameters can also be cached. Subsequent requests for addresses falling within a range of identified sectors can be handled without performing all of the typical operations required for logical block address to physical address translation. The number of non-defective sectors can be used to improve logical block address to physical block address translation. Other information such as the number of sectors on a track or in a group and skew parameters can be used to improve physical block address to cylinder number, head number, and sector number translation. In addition, information relating to the data zones of recently accessed addresses of rotatable storage media can also be cached to memory.

### BACKGROUND

Systems including rotatable storage media, such as magnetic disc drives and optical disc drives, are an integral part of computers and other devices with needs for large amounts of reliable memory. Systems including rotatable storage media are inexpensive, relatively easy to manufacture, forgiving where manufacturing flaws are present, and capable of storing large amounts of information in relatively small spaces.

One of the many advantages of disc drives is their capability to accommodate manufacturing defects in storage media. Disc drives are capable of accommodating defective sectors in storage media by simply not using any defective sectors. Host devices can access physical addresses or sectors of the storage media without knowledge of internal drive architecture and defective sector information by interfacing with the media using logical block addresses. A disk drive can then translate a logical block address to a physical address of the storage media using various systems and methods which account for drive architecture and defective sectors. As data storage capacity and the number of sectors in rotatable storage media increases, the efficient translation of logical block addresses to physical addresses of the rotatable storage media becomes increasingly important.

### BRIEF DESCRIPTION OF THE DRAWINGS

FIG. 1 is a diagram of components of an exemplary disk drive that can be used in accordance with one embodiment of the present invention.

FIG. 2 is a top view of a rotatable storage medium that can be used in the drive of FIG. 1.

FIG. 3 is an illustration of a track of the medium of FIG. 2.

FIG. 4 is an illustration of a track having an ID field before each data sector.

FIG. 5a is a listing of sectors of a rotatable storage medium and corresponding physical and logical block addresses.

FIG. 5b is a defect table that can be used to describe the sectors of FIG. 5a.

FIG. 6 is a flowchart for translating LBA's to physical addresses in accordance with an embodiment.

FIG. 7 is a flowchart in accordance with an embodiment that can be used to translate the LBA to a PBA at step 615 of FIG. 6.

FIG. 8 is a cache descriptor having appended information relating to address translation and data zones in accordance with an embodiment.

FIG. 9 is a flowchart in accordance with an embodiment that can be used to translate the PBA to a CHS address at step 618 of FIG. 6.

FIG. 10 is a flowchart in accordance with an embodiment for determining physical block addresses and cylinder, head, and sector addresses.

FIG. 11 is a flowchart in accordance with an embodiment for maintaining data zone information.

FIG. 12 is a side view of a disk drive in which a group architecture of tracks is used.

FIG. 13 is a side view of a disk drive in which a group architecture of tracks is used and wherein the tracks are accessed in a serpentine fashion.

FIG. 14 is a diagram illustrating ranges of LBA's having corresponding cache entries.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in data processing terms, such as data, selection, retrieval, generation, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical, optical, and/or biological components of a processor and its subsystems.

Various operations will be described as multiple discrete steps in turn, in a manner that is most helpful in understanding the present invention, however, the order of description should not be construed as to imply that these operations are necessarily order dependent.

Various embodiments will be illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

Systems and devices in accordance with the present invention take advantage of techniques for bypassing the full translation of logical block addresses to physical addresses of rotatable storage media. Storing information relating to the translation of a logical block address can enable later translations to bypass some operations typically required in a full translation of the logical block address. For example, an entry in cache or other suitable memory can identify a recently requested logical block address, a corresponding physical address, and a range of non-defective sectors. If a request is received for a logical block address corresponding to a physical address identified by a range in a cache entry, the information stored in memory can be used to determine the physical address corresponding to the requested logical block address. The physical address can be determined without performing all of the operations typically required to determine a physical address corresponding to a logical block address. In one embodiment, defective sector management can be bypassed when a requested address falls within an identified range of non-defective sectors. By storing information relating to the translation of logical block addresses and data zone information for logical block addresses, efficiency in accessing and translating addresses can be increased.

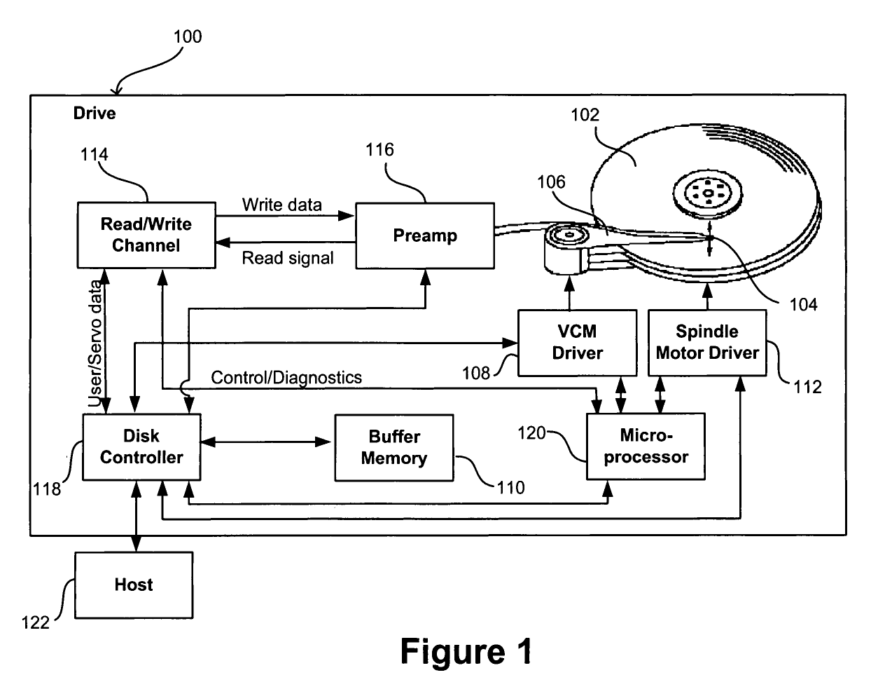

Systems and devices in accordance with embodiments of the present invention provide for performance in storage devices, such as magnetic disk drives and laser-recordable media. Referring to FIG. 1, for example, there is shown a typical disk drive 100 that can be used in accordance with one embodiment of the present invention. Disk drive 100 includes at least one rotatable storage medium 102 capable of storing information on at least one surface of the medium. Numbers of disks and surfaces may vary by disk drive. In a magnetic disk drive as described below, storage medium 102 is a magnetic disk. A closed loop servo system, including an actuator arm 106, can be used to position head 104 over selected tracks of disk 102 for reading or writing, or to move head 104 to a selected track during a seek operation. In one embodiment, head 104 is a magnetic transducer adapted to read data from and write data to the disk 102. In other embodiments, head 104 can include a separate read element and write element. The separate read element can be a magnetoresistive head, also known as an MR head. It will be understood that multiple head configurations may be used. If multiple storage disks are used within a drive or if both sides of one storage disk are used to store data, multiple heads can be used to access the individual storage disks or surfaces.

The servo system can include a voice coil motor driver 108 to drive a voice coil motor (VCM) (not shown) for rotation of the actuator arm 106, a spindle motor driver 112 to drive a spindle motor (not shown) for rotation of the disk 102, a microprocessor 120 to control the VCM driver 108 and spindle motor driver 112, and a disk controller 128 to transfer information between the microprocessor, memory, read/write channel, and a host 122. A host can be any device, apparatus, or system capable of utilizing the data storage device, such as a personal computer or Web server. In various embodiments, drives can include a processing component which can include disk controller 128, processor 120, or both. The processing component can be used to perform various processing operations. Disk controller 128 can include an interface controller in some embodiments for communicating with a host and in other embodiments, a separate interface controller can be used. The processor, or microprocessor 120, can process information for the disk controller 128, read/write channel 114, VCM driver 108, or spindle driver 112. The microprocessor can also include a servo controller, which can exist as circuitry within the drive or as an algorithm resident in the microprocessor 120, or as a combination thereof. In other embodiments, an independent servo controller can be used. Additionally, microprocessor 120 may include some amount of memory such as SRAM or an external memory such as SRAM 110 can be coupled with the microprocessor. Disk controller 128 can also provide user data to a read/write channel 114, which can send data signals to a current amplifier or preamp 116 to be written to the disk(s) 102, and can send servo signals and/or user data signals to the microprocessor 120 or disk controller 128. Disk controller 128 can also include a memory controller to interface with memory 118. Memory 118 can be DRAM in some embodiments that can be used as a buffer memory.

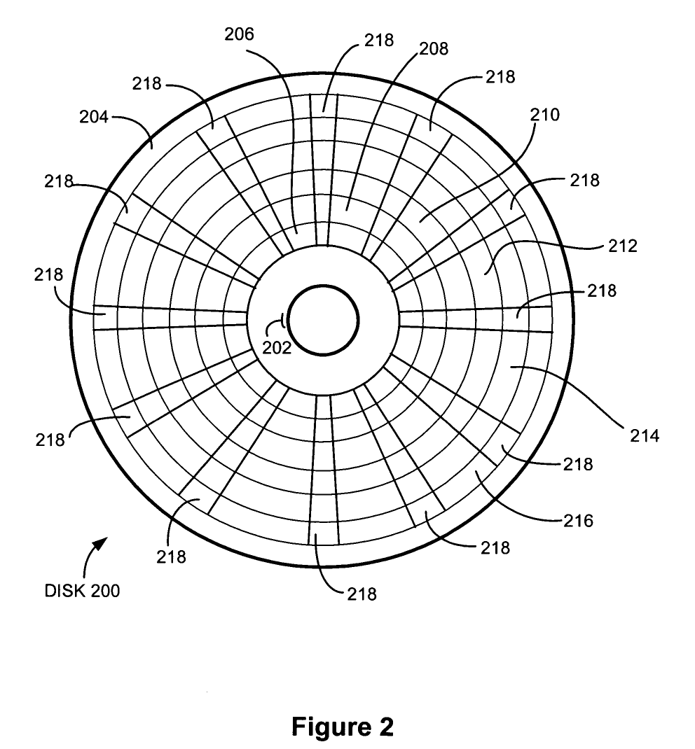

The information stored on a disk can be written in concentric tracks. FIG. 2 is a top view of an exemplary rotatable storage disk 200. A multiplicity of concentric tracks extend from near an inner diameter (ID) 202 of the disk 200 to near an outer diameter (OD) 204. These tracks may be arranged within multiple data zones 206-216, extending from the ID 202 to the OD 204. Data zones can be used to optimize storage within the data storage tracks because the length of a track in inner data zone 206 may be shorter than the length of a track at outer zone 216. While eight zones are shown in FIG. 2, any number of zones may be used. For example, sixteen zones are used in one embodiment. Disk 200 includes multiple servo sectors 218, also referred to as servo wedges. In this example, servo sectors 218 are equally spaced about the circumference of storage disk 200.

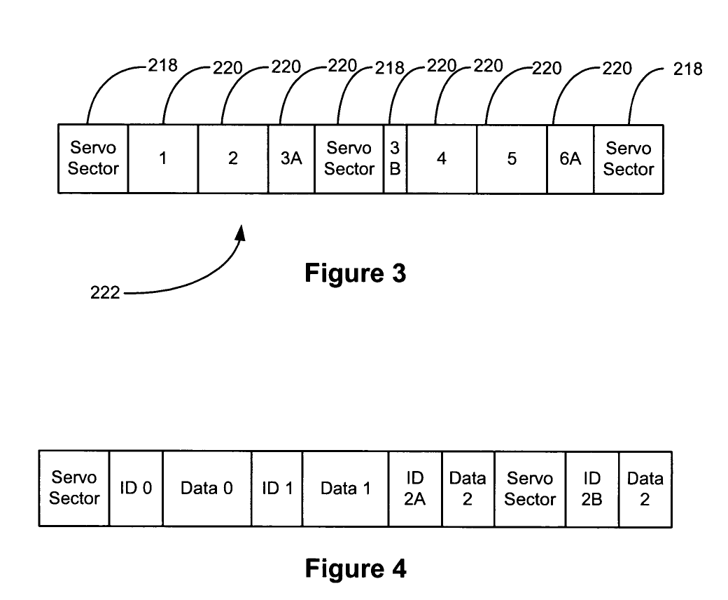

An exemplary track 222 of storage disk 200 is illustrated in FIG. 3. Servo sectors 218 split the track 222 into multiple data sectors 220. Each servo sector 218 is associated with the immediately following data sectors 220, as defined by a direction of rotation of disk 200. As is illustrated, servo sectors can split data sectors resulting in a non-integer number of data sectors between servo sectors. The number of tracks in a data zone may vary by embodiment. In one embodiment, for example, the number exceeds two thousand. For drives having more than one storage disk, vertically aligned tracks can define a cylinder. Individual tracks within a cylinder can be accessed by selecting among the heads without moving the heads to a new track location.

Data sectors on discs can be accessed according to the location of the sector on a storage medium. The location of a sector on a storage medium is often referred to as a physical address. Physical addresses can be identified using a cylinder, head, and sector component and are often referred to as CHS addresses. In many disc drives, logical block addresses (“LBA”) are used by host devices to access data on a disc. LBA's allow the host to interface with the drive without knowledge of information relating to drive geometry, defects in storage media, or other internal characteristics of the drive. A host can access one or more data sectors by passing a start LBA and/or a sector count to the drive. Drive hardware, software, and/or firmware can translate the LBA and sector count requested by a host into one or more physical addresses on the drive media to access sectors. In one embodiment of the present invention, a processing component can be used to perform translations and related processing as will be described herein. By way of a non-limiting example, the processing component can include one or more of microprocessor 120 and disk controller 128. In another embodiment, a dedicated processor or controller within the processing component can be used to perform some or all of the operations as described herein.

Logical block addressing can be used to access data sectors on a drive by assigning sequential numbers, typically beginning with 0, to physical sectors of the drive. A drive can translate an LBA to a physical sector of the drive using known mathematical algorithms and the drive's internal geometry. For example, in a drive having no defects that uses a sequential method of addressing sectors without skews, an LBA can be equal to (a cylinder #)*(# of sectors per cylinder)+(a head #*# of sectors per track)+(a sector #).

Numerous methods and algorithms are known for converting or translating LBA's to physical addresses, all of which are within the scope of the present disclosure. In an exemplary method, a cylinder number can be determined by dividing an LBA by a number of sectors per cylinder (SPC) and rounding down to the nearest whole number. A head number can be determined by dividing an LBA by a number of sectors per cylinder and returning the remainder (LBA mod SPC). If the remainder is less than or equal to the number of sectors in a first track of the cylinder, head 0 should be returned. If the remainder is greater than the number of sectors in a first track and less than or equal to the number of sectors in a second track, head 1 should be returned, etc. A sector number can be determined by dividing an LBA by a number of sectors per track and returning the remainder.

Consider a simplified drive without track skews, having a geometry of 10 cylinders, 2 heads, and 10 sectors per track. A host can access data stored within the drive on a storage disk by passing an LBA to the drive. If the host requests access to LBA 32, the drive can determine the corresponding physical address for LBA 32. In the 2 head, 10 sector per track format, each cylinder includes 20 sectors. Therefore, LBA 32 corresponds to the thirteenth sector within the second cylinder (cylinder 1). Since there are 2 heads and 10 sectors per track, the thirteenth sector within the cylinder is accessed by the second head (head 1) and is the third sector (sector 2) of the track accessed by head 1. Therefore, LBA 32 corresponds to the physical address: cylinder 1, head 1, and sector 2.

In more advanced drive architectures, LBA's are not always assigned sequentially to sectors on the media. Numerous drive architectures and methods for assigning LBA's to physical addresses are known including, for example, skew architectures and serpentine architectures. In drives utilizing a skew architecture, for example, a number of sectors can initially be skipped to accommodate the time required to switch heads when transitioning between tracks. In an exemplary drive having 2 heads and 20 sectors per cylinder, LBA's 0-9 may be assigned sequentially to sectors 0-9 of cylinder 0. LBA 10, however, may be assigned to sector 14 of cylinder 0 and head 1. LBA's can be assigned sequentially and wrap-around, such that LBA 19 is assigned to sector 13 of cylinder 0.

In other drive architectures, tracks of one or more disks and disk surfaces can be organized into groups. The number of servo tracks within a group can be an integer value and be constant throughout the group. The number of data tracks can also be an integer but can vary for each disk surface according to the head used for the particular surface. The track-to-track skew within a single group on a single surface will be the same. A group boundary can be chosen to coincide with a data zone boundary.

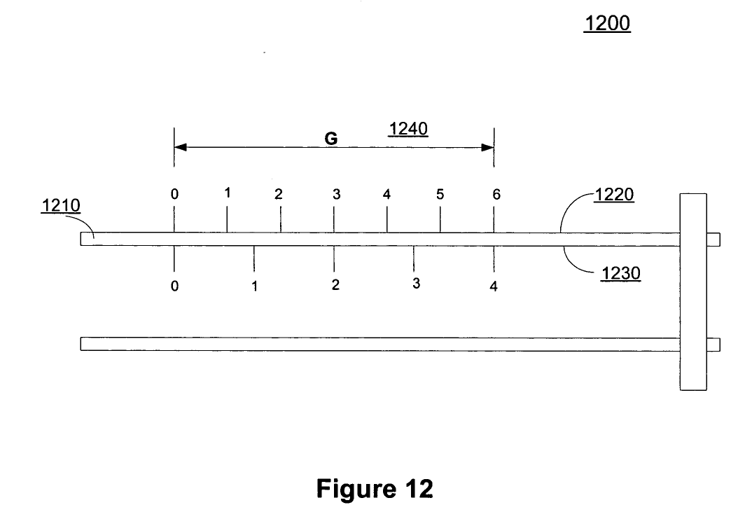

FIG. 12 is a side view of a disk drive 1200 that includes a disk 1210 having an upper surface 1220 and a lower surface 1230. The inner diameter of the disk corresponds to the right side of the page while the outer diameter of the disk corresponds to the left side of the page. A group 1240 is configured to have boundaries in roughly the same physical location on the upper and lower surface of disk 1210. The group is configured in the same general location and has the same rough boundaries on other disk surfaces within the drive as well (not shown). Upper surface 1220 contains six data tracks within group 1240 while lower surface 1230 contains four data tracks within group 1240. Thus, group 1240 contains an integral number of data tracks that are constant over a surface of a disk, but that vary between different disk surfaces.

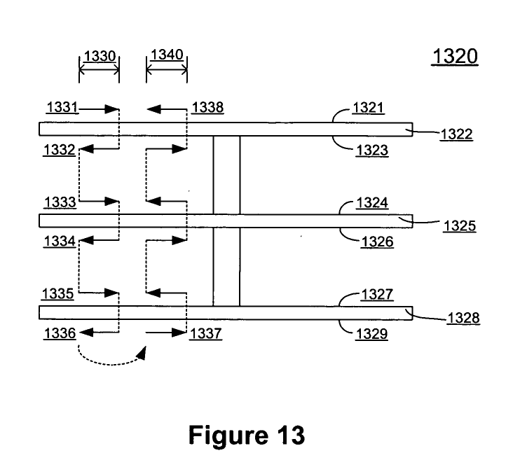

In one embodiment, a group of tracks can be accessed in a serpentine fashion. FIG. 13 is a side view of a disk drive including disks 1322, 1325, and 1328, wherein arrow 1331 is in a direction corresponding to the ID and arrow 1338 is in a direction corresponding to the OD. Disk 1322 includes an upper surface 1321 and a lower surface 1323. Disk 1325 includes an upper surface 1324 and a lower surface 1326. Disk 1328 includes an upper surface 1327 and a lower surface 1329. A serpentine pattern of R/W operation is shown by R/W directional arrows 1331, 1332, 1333, 1334, 1335 and 1336 over a group area 1330. The arrows can represent the order of assignment of logical block addresses to the sectors within the group as well as an order for reading and/or writing.

In one embodiment, a first R/W operation is performed along disk surface 1321 in the direction (towards the inner diameter) of directional arrow 1331. Once the R/W operation has spanned the entire group 1330 having an integral number of data tracks on surface 1321, the R/W operation continues upon disk surface 1323. The last data track accessed in direction 1331 is located approximately opposite to the first data track accessed in direction 1332. This provides for minimal head movement in accessing data from consecutive tracks located on different disk surfaces. As shown, the R/W operation on disk surface 1323 occurs over the same configured group 1330 but in a direction 1332 that is opposite of direction 1331 of the R/W operation on surface 1321. Once the R/W operation on surface 1323 is completed for the group 1330, R/W operation continues upon disk surface 1324 of disk 1325. For a hard disk drive accessed in a serpentine fashion, consecutively accessed sector locations are configured to be consecutive logical memory locations. A group number can be substituted for the cylinder number in a CHS address. A more detailed description of groups and serpentine architectures can be found in U.S. patent application Ser. No. 10/387,789 (Attorney Docket No. PANA-1006US1), entitled A METHOD FOR CONSTRAINED IMPLEMENTATION OF VARIABLE DATA TPI, by Fernando Zayas et al., filed Mar. 13, 2003.

In order to accurately translate LBA's to physical addresses, drives must also account for translation discontinuities within the media. Defective sectors on storage media can cause one type of translation discontinuity. For example, dust particles and other contaminants introduced during the manufacturing process can render sectors of the storage media defective and unavailable for use. In addition to manufacturing defects, sectors can also become defective during use of a drive by consumers. These defects are often referred to as “grown” defects.

In order to accurately translate LBA's to physical addresses on the media, many drives utilize physical block addresses (PBA's). As discussed, LBA's are sequential numbers, typically beginning with 0, assigned to physical sectors on the media. Each available non-defective sector on the media has a corresponding LBA. PBA's are also sequential numbers corresponding to physical sectors on media. PBA's, however, are located at fixed locations and are assigned to each sector of the a drive without regard for defective sectors. When a disk has defective sectors, PBA's corresponding to defective sectors are skipped, resulting in a “slipped” arrangement of LBA's corresponding to PBA's. If a medium has no defective sectors, LBA to PBA translation is linear, with each LBA equal to a corresponding PBA. If a drive has defective sectors, however, an offset between PBA's and LBA's exists.

In earlier disc drives, each data sector of a track was preceded by an identification field or ID field. FIG. 4 illustrates a track of the prior art having ID fields. The ID field preceded a data sector and contained information relating to that sector. The ID field often contained one or more of a preamble, an identification address mark, LBA information, and physical address information. The ID field also contained at least one bit that could indicate if a sector was defective or otherwise unavailable to the user. When reading or writing data to a selected track on the disc, a processor adapted to receive this information could simply skip any defective sectors and use the next sector when it encountered a defective sector. Alternatively, the ID field could contain a pointer to another sector of the disc used as a replacement sector for the defective sector. As illustrated by data sector 2, data sectors can be split by servo sectors, resulting in non-integer numbers of data sectors between servo sectors. An improvement to this design was made by using one ID field for all data sectors between servo sectors on a track. The ID field contained information regarding each sector before the next servo sector and included defective sector information for each of those sectors. This format had the advantage of using a smaller area for identification fields, thereby yielding a larger area for data storage.

In more modern disc drives, identification fields are not used for each data sector or each sector occurring between wedges on a track. Tracks on the disc often contain only data sectors and servo wedges. Identification information, including defective sector information, can be stored in memory within the drive. This disk architecture may be referred to as a headerless architecture.

Defective sector information can be stored in numerous ways, including as tables within memory. A defective sector table can include numerous types of information relating to the defective sectors. For example, a table can be a simple list of defective sectors, a list of PBA's corresponding to defective sectors, and/or LBA's having an associated defective sector. A table can also contain slip or offset values for addresses, alternate or substitute addresses, or PBA's for LBA's having associated defective sectors. Defective sector information can be stored in non-volatile memory such as a flash memory or directly on a selected portion of the disc, often in a selected area outside of the data tracks that holds customer information. In order to handle grown defects, the drive can test the media while in use by the consumer to update a defective sector table or to provide a second table of grown defects. Any table or other format of defective sector information can be used in accordance with embodiments of the present invention.

In many drives, defective sector information is read from a permanent storage location and stored in a faster memory such as random access memory (“RAM”) when the drive is powered up. The information can then be accessed more quickly to accurately translate LBA's to physical addresses of the storage medium. Numerous methods known for handling defective sectors on discs can be used in accordance with embodiments of the present invention.

In one defect management method, often referred to as “slipping” a list of defective sectors is used to “slip” an LBA in order to accommodate defective sectors. Defective sectors are not allocated to an LBA and are skipped when accessing requested addresses. In a slipping method, a number of defective sectors up to and including the physical address that would correspond to the requested LBA is determined in order to determine the correct PBA corresponding to the requested LBA.

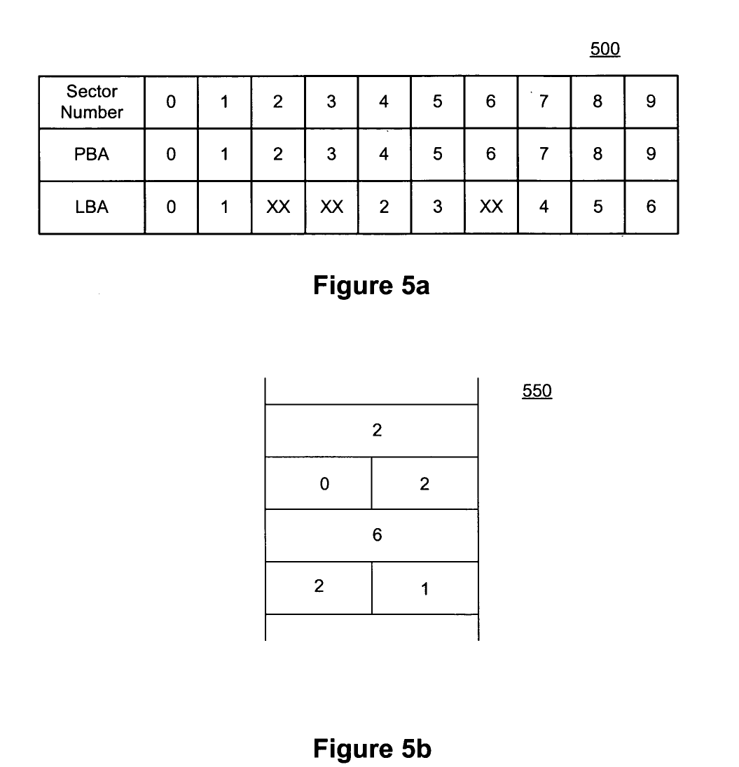

FIG. 5a is a listing of physical sectors on a disk illustrating a corresponding LBA and PBA for each sector. FIG. 5b is an exemplary defect table 550 that can be used to describe the sectors of FIG. 5a. Sectors 2, 3, and 6 are defective and thus, have no logical addresses assigned to them. The LBA's corresponding to the PBA's of the defective sectors are slipped, resulting in the arrangement as shown. Table 550 includes an entry to represent the second defective sector. The defective sector can be identified by an entry 554 for the PBA (2), an entry 556 for the number of defective sectors (0) up to PBA 2, and an entry 558 for the number of adjacent defective sectors (2) following PBA 2. A request for an address such as LBA 4 can be translated by searching for the PBA entry equal to or larger than the requested LBA. The number of defective sectors can be determined and added to the requested LBA to slip the LBA. If the resulting PBA (6) overlaps another entry in the table, the additional defective sectors can be slipped. The iterative process can continue until a corresponding PBA is determined (7). After determining the corresponding PBA, the PBA can be translated to a CHS address.

In other methods, defective sectors can be mapped to other sectors on the drive. For example, in a block relocation method, rather than slip all addresses to accommodate defects, an LBA for a defective sector can be reassigned to another sector.

When translating a logical to physical address, a defective sector table is generally accessed at least once during address translation in order to translate an LBA to a PBA. The table can be accessed by performing a binary search of entries in the table to determine defective sector information necessary for an address translation. Accessing the defective sector information, often stored in DRAM, can slow down the process of translating requested LBA's to PBA's and increase drive access times. In addition to the time spent performing a binary search of defect table entries, it may take several wait states to access the DRAM, as the DRAM may also be caching recently written or read data or handling other system operations. After a corresponding PBA has been determined, the PBA must be translated to a CHS address on the media, resulting in further access delays.

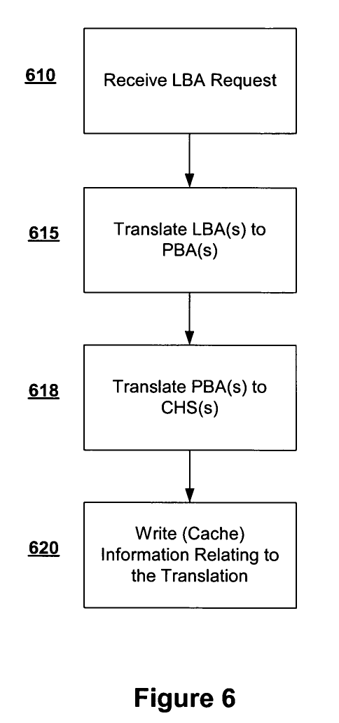

FIG. 6 is a flowchart of a method for translating LBA's to physical addresses in accordance with an exemplary embodiment of the present invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. At step 610, a request for one or more LBA's can be received. The request may be for one LBA, or a start LBA and a number of sectors following the LBA. At step 615, the requested LBA can be translated to a PBA. A table of defective sector information can be accessed in order to make an accurate translation of LBA to PBA as previously described. At step 618, the PBA can be translated to a CHS address on the media. At step 620, information relating to the translation of the LBA can be written to memory. Information relating to the translation of the requested LBA to a PBA and/or a PBA to a CHS address can be written to memory.

The memory used to store information relating to translation of the LBA can be a faster memory such as SRAM, for example, to permit increased performance in translation time. The SRAM may be included within a processor as tightly coupled RAM or located external to a processor within the disk drive. The information need not be written to a faster memory, however, and can be written to any memory suitable to store the information, including the memory used to store the defect table. Translation time can be decreased when the information is stored in a memory such as that used to store the defect table by the fact that a smaller quantity of information has to be searched to determine defective sector information.

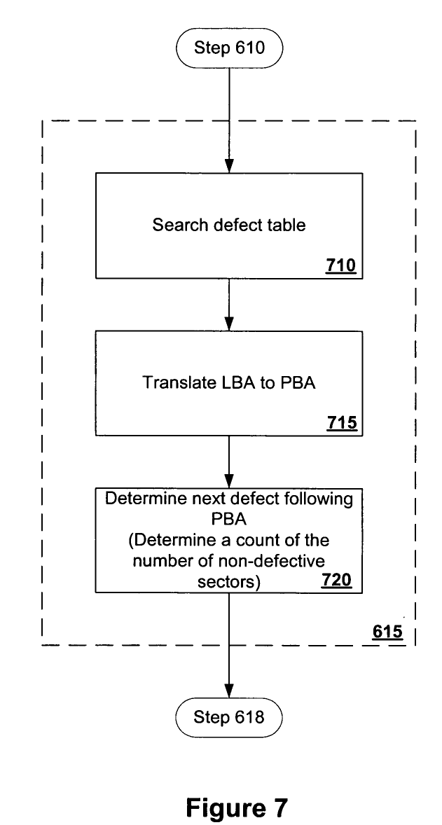

FIG. 7 is a flowchart in accordance with an embodiment that can be used to translate the LBA to a PBA at step 615 of FIG. 6. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. After receiving the LBA a defective sector table can be searched at step 710. At step 715, the LBA can be translated to a PBA using information determined from searching the defect table. For example, the defect table can be used to determine a number of sectors to slip the requested LBA in embodiments utilizing such an approach to accommodate defective sectors. At step 720, a PBA corresponding to a next defective sector that follows the sector corresponding to the requested LBA can be determined. In place of or in addition to determining the PBA, the number of sectors from the requested LBA to the next defect can be determined at step 720.

The use of the term next when referring to a next defective sector or a next sector refers to a next defective sector or a next sector given the architecture for assigning LBA's to physical addresses for a particular drive. For example, the next sector after the last sector of track 0 in an architecture using skewing with an offset of 5 sectors may be the fifth sector of track 1. Similarly, the term consecutive is also used to refer to sectors that are consecutive in terms of the drive's architecture rather than physically consecutive. In our example, the last sector of track 0 and the fifth sector of track 1 are consecutive given the architecture for assigning LBA's to physical sectors. The use of the term close when referring to a sector being closer to one sector than another sector refers to a sector being closer under the assignment of LBA's to physical sectors. In our example the last sector of track 0 is closer to the fifth sector of track 1 than to the fourth sector of track 1 even though the last sector of track 0 and the fourth sector of track 1 may be in closer physical proximity. The two sectors are closer under the drive's architecture for assigning LBA's to physical addresses.

At step 620, information relating to the translation of the LBA to a PBA can be written to memory. The information written to memory can be stored in a table. By way of a non-limiting example, an entry can include a requested LBA and a count of the number of sectors starting next to the corresponding physical address that are free of defects, including or not including the requested physical address. Other information written to memory in addition to or in place of the LBA can include the corresponding PBA and a slip value associated with the LBA.

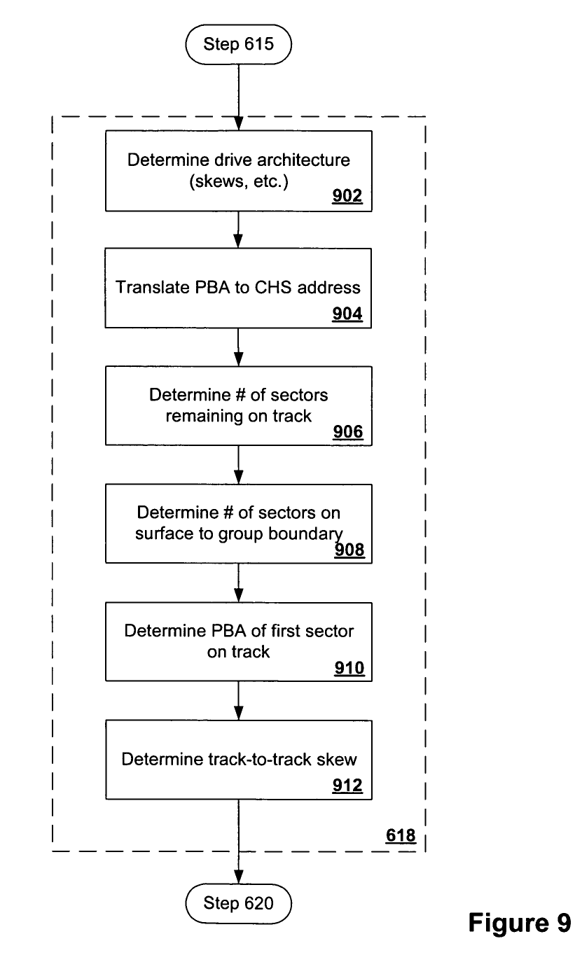

FIG. 9 is a flowchart in accordance with an embodiment that can be used to translate the PBA to a CHS address at step 618 of FIG. 6. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. Translation to a CHS address will vary by drive architecture and embodiment. For example, information relating to drive architecture such as parameters including track-to-track skew, head switch skew, etc. can be determined in drives including such architecture. At step 902, a search of a drive format table or global format table can be made if necessary. A table may include skew, serpentine, and other parameters relating to address translation arranged by track, zone, cylinder, or group. Various factors may be needed to determine a CHS address, such as a track-to-track skew and/or skew when switching heads or surfaces. Using any required information, a CHS address corresponding to the PBA can be determined at step 904.

At steps 906-912, various information relating to drive architecture or address translation can be determined if not already determined. This information can be cached to further improve subsequent translations. At optional step 906, the number of sectors remaining on the track of the CHS address and that follow the CHS address can be determined. At optional step 908, the number of sectors on the surface with the CHS address that follow the CHS address and precede a group boundary can be determined (in drives utilizing groups). At optional step 910, the PBA corresponding to the sector that begins the track under the logical block addressing scheme can be determined. At optional step 912, the track-to-track skew of the tracks in the group of the current of the CHS address can be determined.

At step 620, information relating to the translation of the PBA to a CHS address can be written to memory. The information written to memory can be stored in a table as with the information relating to translation of the LBA to PBA. An entry can include a cylinder, head, and sector component corresponding to the requested LBA. In one embodiment, the information relating to the CHS translation can be written to an individualized table or cache entry for such information.

In one embodiment, the information written to memory at step 620 can be written to a table created specifically to handle such information. In other embodiments, the information can be appended to a cache descriptor. Cache descriptors are well known in the art and typically provide information relating to cached segments of user data. Disk drives often include a cache memory such as DRAM for caching user data that was recently written to or read from a storage disk. If a request is received for data within a cached range of user data, the information can be retrieved from the cache memory rather than the disk. Cache descriptors, which can be stored in a memory such as SRAM, can identify and describe the cached data. When user data is read from or written to a disk, the data can be cached and a suitable cache descriptor created. In accordance with an embodiment, information relating to the translation of the requested LBA(s) can be appended to the cache descriptor.

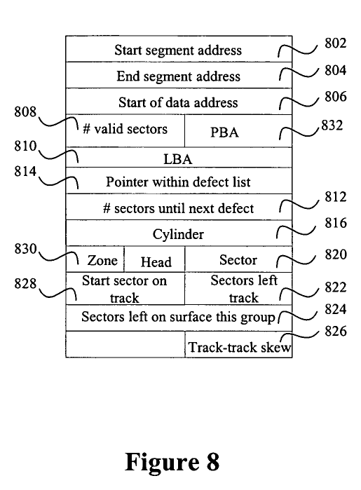

FIG. 8 is an exemplary cache descriptor 800 in accordance with an embodiment. The first entry 802 of the descriptor contains a pointer to the start of a first segment of user data stored in cache memory. Entry 804 contains a pointer to the end of the first segment of user data. Entry 806 contains a pointer to where valid data starts in the first segment. Valid data in the cache entry may not start at the start of the segment in situations where a subsequent read/write operation has resulted in the current data corresponding to the beginning portion of the segment being cached in a second segment. Entry 808 contains a count of the number of valid sectors of user data that are contained in the cached segment of user data. Entry 810 is the LBA corresponding to the start of valid data within the cached segment. Cache descriptors containing entries such as those of 802-810 are well known in the art. It should be noted that other entries such as a flags field are not discussed or shown as they are not pertinent to the present discussion.

In accordance with an embodiment, entry 812 can be appended to the cache descriptor as part of writing information relating to the translation of the LBA to a PBA at step 620. Entry 812 can contain a count of the number of sectors from the entry's LBA to the next defective sector as determined at step 720. As discussed, an LBA or PBA corresponding to the next defective sector can be written to memory in place of or in addition to the count of the number of sectors. In one embodiment, another entry 814 can be made that contains a pointer to the next PBA entry in the defect table following the PBA of the cached PBA. Entry 832 can include the PBA corresponding to the LBA in entry 810.

Although the information written to memory at step 620 can be written in any suitable format, appending it to a cache descriptor can provide for increased performance. When one or more LBA's are requested, a cache descriptor can be accessed to determine if the data is located in cache memory. If it is not, the cache descriptor can be accessed to determine if the requested LBA is within a range of non-defective sectors identified by an entry. If the LBA is within the range identified by the cache descriptor, the corresponding PBA can be determined using information from the cache descriptor rather than from a search of a defect table. If a pointer to the entry in the defect table following the entry's LBA has been made and a requested LBA is not within the range identified by the cache descriptor, a search of the defect table can begin at the location identified by the pointer rather than from the start of the defect table.

Information relating to a PBA to CHS translation can also be appended to a cache descriptor. As shown in the cache descriptor of FIG. 8, entries 816, 818, and 820 include the cylinder, head, and sector components of the CHS address corresponding to the requested LBA. Entry 822 contains a count of the number of sectors on the track that follow the CHS address. The physical address corresponding to a subsequent LBA request within this range can be located by simply subtracting the cached LBA from the requested LBA and adding the difference to the sector component of the CHS address. Entry 824 contains a count of the number of remaining sectors on the surface with the CHS address that precede a group boundary. Entry 826 contains the track-to-track skew between tracks in the group of the CHS address. The physical address corresponding to a subsequent LBA request within the range identified by entry 824 but not in the range identified by entry 822 can be located by subtracting the cached LBA from the requested LBA, determining the one track track-to-track skew from entry 826, multiplying the skew by the number of tracks from the present track to the track of the requested LBA, and adding the total skew and difference between LBA's to the sector component of the CHS address. Entry 828 can include the PBA of the CHS address for the starting sector of the track of the CHS address. This address can be used as a reference point when making calculations to determine a CHS address from the other stored information. Other entries not shown can include the number of sectors following the CHS address and within the same group as the CHS address (including sectors on other disk surfaces) and the head switch skew when changing surfaces within the group. A request for an address in this range can be determined by accounting for the track-to-track skew and the head switch skew.

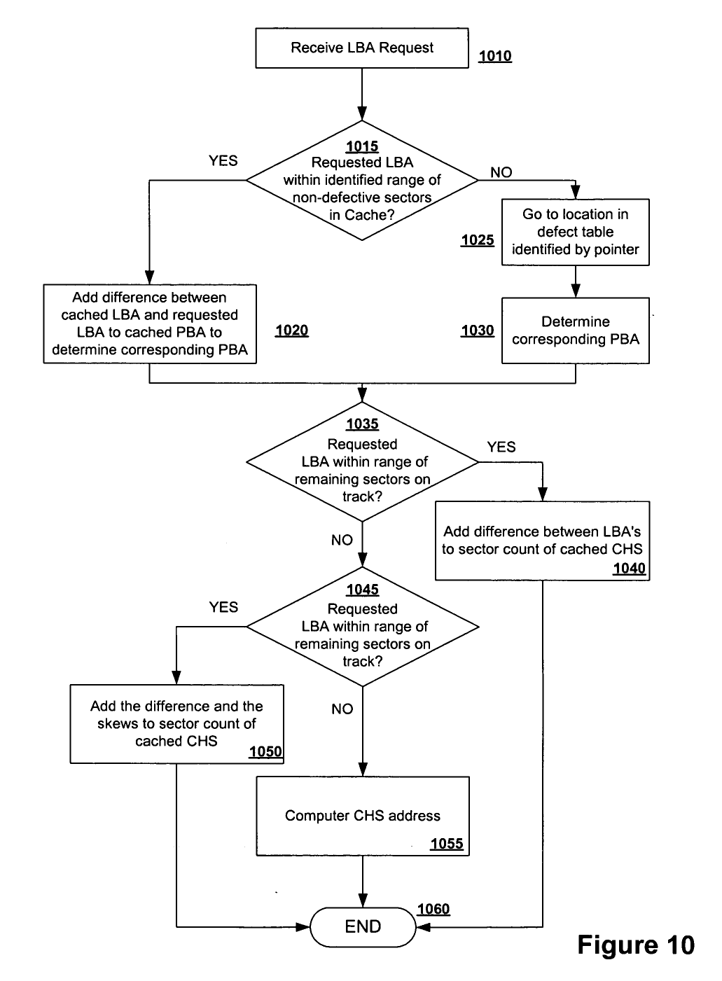

FIG. 10 is a flowchart in accordance with an embodiment for determining physical block addresses and cylinder, head, and sector addresses. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. At step 1010, a request for one or more logical block addresses can be received. At step 1015, whether the requested LBA is within a range of non-defective sectors identified by a cache entry can be determined. Information relating to a previous translations of LBA's can be accessed. One or more cache descriptors can be searched for the closest LBA equal to or less than the requested LBA. The difference between the requested LBA and the cached LBA can be compared to the number of non-defective sectors following the cached LBA as identified. If the difference is less than or equal to the cached number, a search of the defect table can be bypassed. At step 1020, the difference can be added to the cached PBA corresponding to the cached LBA to determine the PBA corresponding to the requested LBA. If the requested LBA is not within a range identified in cache and a pointer to the next defect in the table following the location of the cached LBA, a linear search of the defect table can be performed at step 1025 starting at the identified location rather than by doing a binary search of all entries. After determining the necessary defect information, the corresponding PBA can be determined at step 1030.

After the corresponding PBA has been determined at step 1020 or 1030, whether the requested LBA is within a range of identified sectors remaining on the track of the cached CHS can be determined at step 1035. For example, a cache descriptor including information relating to previous translations to CHS addresses can be accessed. In one embodiment, it can be determined whether the difference between the requested LBA and a cached LBA is within a range of sectors left on the track of the cached LBA. This can be done by comparing the difference with a count of sectors such as entry 822. If the difference is within the count, a CHS address corresponding to the requested LBA can be determined by adding the difference to the sector count of the cached CHS address at step 1040.

If the CHS address is not within the range of sectors remaining on the track, whether the CHS address corresponding to the PBA is within a range of identified sectors remaining on the surface of the CHS address and before a group boundary can be determined at step 1045. The difference between the requested LBA and cached LBA can be compared to a count of sectors remaining on the surface such as can be identified by an entry 824. If the difference is within the count, the track-to-track skew for the group can be determined from an entry such as 826. The total skew (given the track displacement to the CHS address which can be computed by dividing the difference in LBA's by the number of sectors per track) can be added to the difference in LBA's. The sum can be added to the sector component of the cached CHS address to determine the CHS address of the requested LBA at step 1050. In this manner, many of the calculations normally required for a full translation to a CHS address can be bypassed.

If the CHS address is not within any identified range, a full translation using known techniques dictated by drive architecture can be computed at step 1055. Translation to a CHS address is then complete at step 1060.

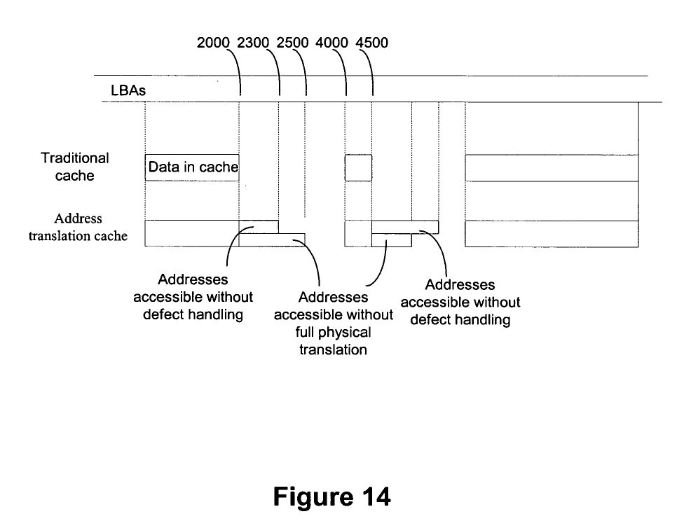

FIG. 14 is a diagram illustrating ranges of LBA's having corresponding cache entries. At the top of the diagram, and listed from left to right, is a subset of LBA's of a disk drive. The user data corresponding to LBA's 1000-2000 is located in a traditional cache memory. The user data for these LBA's can be accessed without accessing a disk. Rather, the data can be retrieved from a cache memory such as DRAM. The data corresponding to LBA's 2001-2300 is not located in cache. However, an address translation cache indicates that there are no defects in this range. Thus, the PBA corresponding to an LBA in this range can be determined without referencing a defect table. The difference in a requested LBA and the cached LBA (LBA 1000) can be determined and added to the PBA for the cached LBA. The address translation cache further indicates that the CHS addresses corresponding to LBA's 2001-2500 can be determined without a full physical translation. These addresses are within an identified range in the address translation cache (such as on the same track as the cached CHS, on the same surface, etc.). The CHS address corresponding to one of these LBA's can be determined by relatively simple mathematical operations using the cached CHS as a reference. If necessary, information such as track-to-track skew etc. can be determined from the address translation cache.

Other information relating to sectors on the media can also be cached or written to memory to increase drive performance and decrease access times. For example, data zones are often used to increase storage capacity on a disc surface. Data zones generally include multiple tracks and extend from an inner diameter (“ID”) of a disc to an outer diameter (“OD”) of a disc. Because track length and relational speed varies from an ID of the disc to an OD of the disc, data can be written and read at different rates depending on data zone to maximize storage capacity on the disk. In order to properly read and write data within a zone, zone tables can be used to store information relating to the data transfer rate and other parameters for data zones. As with defect tables, this information is often stored on allocated sectors of the disc surface and written to DRAM during start up of the drive to increase performance. The use of data zones is often referred to as zone bit recording.

Some drives utilize different zone formatting for different heads. For example, a better head may be assigned a more aggressive zone format (such as higher data transfer frequencies or more sectors per track). Thus, two sectors in the same zone that are accessed by different heads (such as sectors on different disk surfaces) may reference different zone parameters and data zone tables. Accordingly, a zone and head number used to access a sector in such embodiments can be determined.

In one embodiment, setting up parameters for a zone can include passing a data track number as input to determine a zone number. In other embodiments, a track and head number can be passed as an input. By passing the track and/or head number, a zone number and then zone parameters can be determined. In one embodiment, zone tables are addresses by a table of zone pointers kept for each head. The zone table can contain information regarding zone boundaries such as the number of servo tracks or groups per zone boundary as well as data zone parameters such as a frequency for reading and writing data in a zone. Using zone pointers for each head allows zone tables to be shared between heads while only the tables of pointers are unique for each head.

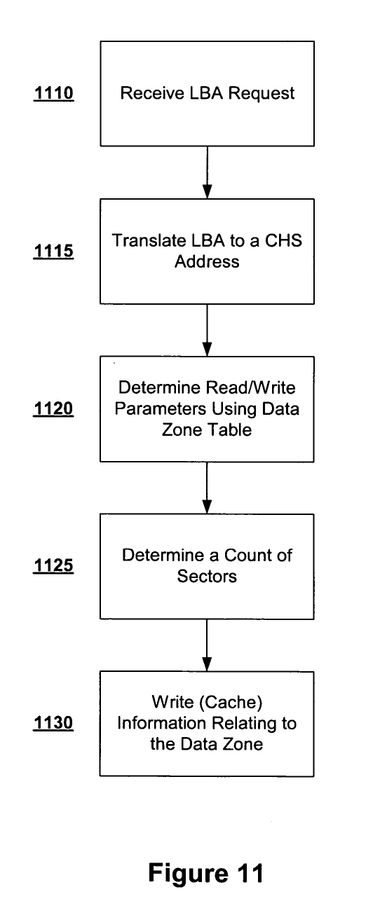

FIG. 11 is a flowchart in accordance with an embodiment for maintaining data zone information. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways. At step 1110, a request is received for one or more LBA'S. At step 1115, the LBA(s) is translated to a CHS address as previously described. A data zone and/or read/write data zone parameters for the physical address corresponding to the requested LBA can be determined at step 1120. A data zone table can be searched to determine the data zone and parameters for the data zone of the requested sector. As discussed, a table of pointers to a data zone table may be accessed in some embodiments.

At step 1125, the data zone parameter table can be used to determine a count of the number of sectors starting next to and preceding or following the sector corresponding to the requested LBA that are in the same data zone as the requested address. In one embodiment, the system can use the data zone parameter table to determine a next sector preceding or following a requested sector that is out of the data zone of the requested sector. Information relating to the data zone parameters for the requested sector and/or the number of sectors following or preceding the requested sector are written to memory at step 1130.

In one embodiment, a head and zone number can be written to memory along with the requested LBA and corresponding physical address. Additionally, the number of remaining sectors in the same data zone or in the same data zone and accessed by the same head can be written to memory. In another embodiment, data zone parameters for the cached range of sectors can be written to memory in order to completely bypass a reference to zone tables when a request for a sector in the identified range is received.

In one embodiment, information relating to data zone parameters can be appended to a cache descriptor entry. For example, the entry of FIG. 8 identifies one LBA and various pieces of information that can be used to bypass LBA to PBA and/or PBA to CHS translation. A zone number entry 830 for the sectors identified by the entry for number of sectors left on the track (entry 822) can be made. This zone number will also correspond to the number of sectors left on the surface that are in the same group (entry 824). A request for a sector in either of the ranges of 822 and 824 can be handled by accessing the appropriate zone table at the appropriate location using the cached zone and head number. In another embodiment, the data zone parameters for these sectors can be appended to the descriptor directly. A request for a sector in an identified range can be handled by using the cached parameters.

A subsequent request for a sector within a range identified by the cache entry can be handled without resort to determination of zone numbers and/or zone parameters from pointer and/or zone tables. If a zone and head number is cached, the appropriate zone table can be accessed at the appropriate location to pull out the corresponding zone parameters. If the zone parameters are cached, a zone table need not be accessed at all.

It will be apparent to those of ordinary skill in the art that many of the techniques discussed herein can be repeated to determine additional information that can be written to memory and/or appended to a cache descriptor. For example, a next defective sector following a sector corresponding to a requested LBA can be determined. The number of non-defective sectors beginning next to that sector can be determined. The LBA and PBA of the first non-defective sector in the next range of sectors can be written to memory along with a count of the range of sector. The translation of a subsequently requested LBA to a PBA can be bypassed if it falls in this range. Similarly, additional data zone information can be determined. For example, the first sector in a zone (or first sector after a head switch in the current zone) following a zone or a requested LBA can be determined. A count of the number of sectors in that zone can be determined and cached along with an indication of the first LBA and PBA for that zone. Additionally, ranges of addresses and sectors preceding or following a requested address and their related information can be determined and maintained in memory.

Many features of the present invention can be performed using hardware, software, firmware, or combinations thereof. Consequently, features of the present invention may be implemented using a control mechanism including one or more processors, a disk controller, or servo controller within or associated with a disk drive (e.g., disk drive 100). The control mechanism can include a processor, disk controller, servo controller, or any combination thereof. In addition, various software components can be integrated with or within any of the processor, disk controller, or servo controller.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer or disk drive to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular ICs), or any type of media or device suitable for storing instructions and/or data.

Stored on any one of the computer readable medium (media), the present invention includes software for controlling both the hardware of the general purpose/specialized computer, microprocessor, disk drive, and/or for enabling the computer or microprocessor to interact with a human user of other mechanism utilizing the results of the present invention. Such software may include, but is not limited to, device drivers, operating systems, execution environments/containers, and user applications.

In one embodiment, a system is implemented exclusively or primarily in hardware using, for example, hardware components such as application specific integrated circuits (ASICs). Implementation of the hardware state machine so as to perform the functions described herein will be apparent to persons skilled in the relevant art(s).

Although embodiments described herein refer generally to systems having a magnetic disk, any media, or at least any rotating media, upon which information is written, placed, or stored, may be able to take advantage of embodiments of the invention, as re-writing in accordance with embodiments in optical, electrical, magnetic, mechanical, and other physical systems can be performed.

Although various embodiments of the present invention, including exemplary and explanatory methods and operations, have been described in terms of multiple discrete steps performed in turn, the order of the descriptions should not necessarily be construed as to imply that the embodiments are order dependent. Where practicable for example, various operations can be performed in alternative orders than those presented herein.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. A method to determine addresses of a rotatable storage medium, comprising:
receiving a logical block address;
translating the logical block address to a physical address of the rotatable storage medium;
maintaining information relating to the translation of the logical block address; and
caching the information in memory.

2. The method of claim 1, wherein the step of maintaining information maintains at least one of the logical block address and the physical address.

3. The method of claim 1, wherein the physical address can be one of:
a physical block address (PBA); and
a cylinder, head, and sector (CHS) address.

4. The method of claim 1, further comprising determining a number of non-defective sectors, beginning with a sector next to the physical address.

5. The method of claim 4, wherein determining a number of non-defective sectors includes determining a number of non-defective sectors including the physical address.

6. The method of claim 4, wherein the step of maintaining information maintains at least one of the logical block address, the physical address, and the number of non-defective sectors.

7. The method of claim 4, further comprising determining a slip value for the number of non-defective sectors.

8. The method of claim 7, wherein the step of maintaining information maintains at least one of the logical block address, the physical address, and the slip value.

9. The method of claim 1, further comprising at least one of:
determining a number of consecutive non-defective sectors, beginning with a sector next to the physical address;
determining a number of consecutive non-defective sectors that precede the physical address, beginning with a sector next to the physical address;
determining a number of consecutive non-defective sectors that follow the physical address, beginning with a sector next to the physical address; and
determining a next defective physical address following the physical address.

10. The method of claim 9, wherein the step of maintaining information maintains at least one of the logical block address, the physical address, and the next defective physical address.

11. The method of claim 1, wherein translating a logical block address to a physical address comprises:
translating the logical block address to a physical block address (PBA);
translating the physical block address to a cylinder number, head number, and sector number (CHS) address of the rotatable storage medium.

12. The method of claim 11, further comprising:
determining a number of sectors that follow the CHS address and are on a same track with the CHS address; and
maintaining the number of sectors.

13. The method of claim 11, further comprising:
determining a number of sectors that follow the CHS address, are on a same surface of the rotatable storage medium, and are in a same group with the CHS address; and
maintaining the number of sectors.

14. The method of claim 13, further comprising:
determining a track-to-track skew for the surface and group of the CHS address; and
maintaining the track-to-track skew.

15. The method of claim 1, wherein the logical block address is a first logical block address and the physical address is a first physical block address, further comprising the steps of:
receiving a request for a second logical block address;
determining a second physical block address corresponding to the second logical block address using the maintained information relating to the translation of the first logical block address.

16. The method of claim 15, wherein the maintained information includes a number of non-defective sectors, beginning with a sector next to the first physical block address, wherein the maintained information includes the first physical block address, and wherein the step of determining a second physical block address comprises at least one of:
determining a difference between the first logical block address and the second logical block address;
determining whether the difference is within the number of non-defective sectors;
adding the difference to the first physical block address to determine the second physical block address when the difference is within the number of non-defective sectors.

17. The method of claim 1, wherein the logical block address is a first logical block address and the physical address is a first CHS address, further comprising the steps of:
receiving a request for a second logical block address;
translating the second logical block address to a second physical block address;
determining a second CHS address corresponding to the second physical block address using the maintained information relating to the translation of the first logical block address.

18. The method of claim 1, wherein the step of maintaining information comprises:
writing the memory to a cache descriptor.

19. The method of claim 1, wherein the logical block address is a first logical block address and the physical address is a first physical address, further comprising:
determining a first number of consecutive non-defective sectors, beginning with a sector next to the first physical address;
determining a next defective physical address following the first physical address;
determining a next non-defective physical address following the next defective physical address;
determining a second logical block address corresponding to the next non-defective physical address;
determining a second number of consecutive non-defective sectors, beginning with a sector next to the next non-defective physical address;
maintaining the first logical block address, the first number of consecutive non-defective sectors, the second logical block address, and the second number of consecutive non-defective sectors.

20. A method to access physical addresses of a rotatable storage medium having a plurality of data zones, comprising:
receiving a logical block address;
determining a data zone of the received logical block address;
maintaining information relating to the data zone of the received logical block address; and
caching the information in memory.

21. A method to access physical addresses of a rotatable storage medium having a plurality of data zones, comprising:
receiving a logical block address;
translating the logical block address to a physical address of the rotatable storage medium;
determining a data zone of the physical address;
determining a number of sectors that are in the data zone, beginning with a sector next to the physical address; and
maintaining information relating to the number of sectors.

22. A system to determine addresses of a rotatable storage medium, comprising:
a processing component adapted to receive a logical block address;
the processing component containing instructions to translate the logical block address to a physical address of the rotatable storage medium; and
the processing component containing instructions to maintain information relating to the translation of the logical block address.

23. A computer program product comprising:
a computer usable medium having computer readable program code embodied therein for determining addresses of a rotatable storage medium, the computer readable program code having:
computer readable program code for receiving a logical block address;
computer readable program code for translating the logical block address to a physical address of the rotatable storage medium; and
computer readable program code for maintaining information relating to the translation of the logical block address.
